(19) United States
(12) Patent Application Publication
(10) Pub. No.: US 2011/0161939 A1
(43) Pub. Date: Jun. 30, 2011

(54) APPARATUS FOR DISPLAYING THE RESULT OF PARALLEL PROGRAM ANALYSIS AND METHOD OF DISPLAYING THE RESULT OF PARALLEL PROGRAM ANALYSIS

(76) Inventors: Takehiko Demiya, Ome-shi (JP); Mikito Iwamasa, Tokyo (JP)

(21) Appl. No.: 12/968,129

(22) Filed: Dec. 14, 2010

(30) Foreign Application Priority Data
Dec. 25, 2009 (JP) 2009-296318

(51) Int. Cl. G06F 9/44

(52) U.S. Cl. 717/132

(57) ABSTRACT

According to one embodiment, an apparatus includes a delay data calculator configured to calculate data delay data and task delay data based on a target ability parameter describing an ability of an environment of executing a parallel program, profile data of the parallel program, and a task-dependency graph representing dependence of tasks described in the parallel program, the data delay data representing time elapsing from a start of obtaining variables needed for executing a task comprised in the tasks to acquisition of all of the needed variables, the task delay data representing the time elapsing from the acquisition of the variable to execution of the task, and a display module configured to display, on a display screen, an image showing the task, a task on which the task depends, the task delay data, and the data delay data, based on the task delay data and the data delay data.

### CROSS-REFERENCE TO RELATED APPLICATIONS

This application is based upon and claims the benefit of priority from Japanese Patent Application No. 2009-296318, filed Dec. 25, 2009; the entire contents of which are incorporated herein by reference.

### FIELD

Embodiments described herein relate generally to an apparatus for displaying the result of parallel program analysis, and a method of displaying the result of parallel program analysis, thus giving the programmer the guidelines for improving the parallel program.

### BACKGROUND

Any parallel program executed by a processor having a plurality of processing circuits is optimized so that the computation resources of the processor may be efficiently used.

Jpn. Pat. Appln. KOKAI Publication No. 2008-004054 discloses the technique of first acquiring trace data and ability data associated with the trace data from a memory and then displaying the task transition state based on the trace data and the ability data, both superimposed on a transition diagram. Patent Document 1 discloses the technique of first determining, from trace data, the degree of parallelism corresponding to the operating states of processors and then synchronizing the degree of parallelism with a task transition diagram.

The techniques described above display the task transition diagram and the degree of parallelism, giving programmers the guidelines for increasing the degree of parallelism. To use the computation resources of each processor, however, it is important not only to increase the degree of parallelism, but also to control the delay resulting from the time spent in waiting for the result of any other task or for a processing circuit available for use. The delay may result from the environment in which the parallel program is executed. In this case, the delay can be reduced by changing the environment in which the parallel program is executed.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary block diagram showing the configuration of an apparatus for displaying the result of parallel program analysis, according to an embodiment.

FIG. 2 is an exemplary diagram illustrating the lifecycle of a task.

FIG. 3 is an exemplary diagram visualizing the contents of a task-dependency graph.

FIG. 4 is an exemplary diagram visualizing the contents described in profile data.

FIG. 5 is an exemplary diagram visualizing the contents of a second task-dependency graph prepared by revising the task-dependency graph.

FIG. 6 is an exemplary diagram visualizing the contents described in profile data if the task-dependency graph of FIG. 5 is executed by a multi-core processor that has four processing circuits.

FIG. 7 is an exemplary diagram showing a result of parallel program analysis performed on the basis of a task-dependency graph, delay data 114 (data delay data δ, task delay data ε).

FIG. 8 is an exemplary flowchart showing the sequence of processes performed by the apparatus for displaying the result of parallel program analysis.

### DETAILED DESCRIPTION

Various embodiments will be described hereinafter with reference to the accompanying drawings.

In general, according to one embodiment, an apparatus for displaying the result of parallel program analysis, includes a delay data calculator and a delay data display module. The delay data calculator is configured to calculate first data delay data and first task delay data based on a target ability parameter describing an ability of an environment of executing a parallel program, profile data of the parallel program, and a first task-dependency graph representing dependence of tasks described in the parallel program, the first data delay data representing time elapsing from a start of obtaining variables needed for executing a first task comprised in the tasks to acquisition of all of the needed variables, the first task delay data representing the time elapsing from the acquisition of the variable to execution of the first task. The delay data display module is configured to display, on a display screen, an image showing the first task, a task on which the first task depends, the first task delay data, and the first data delay data, based on the first task delay data and the first data delay data.

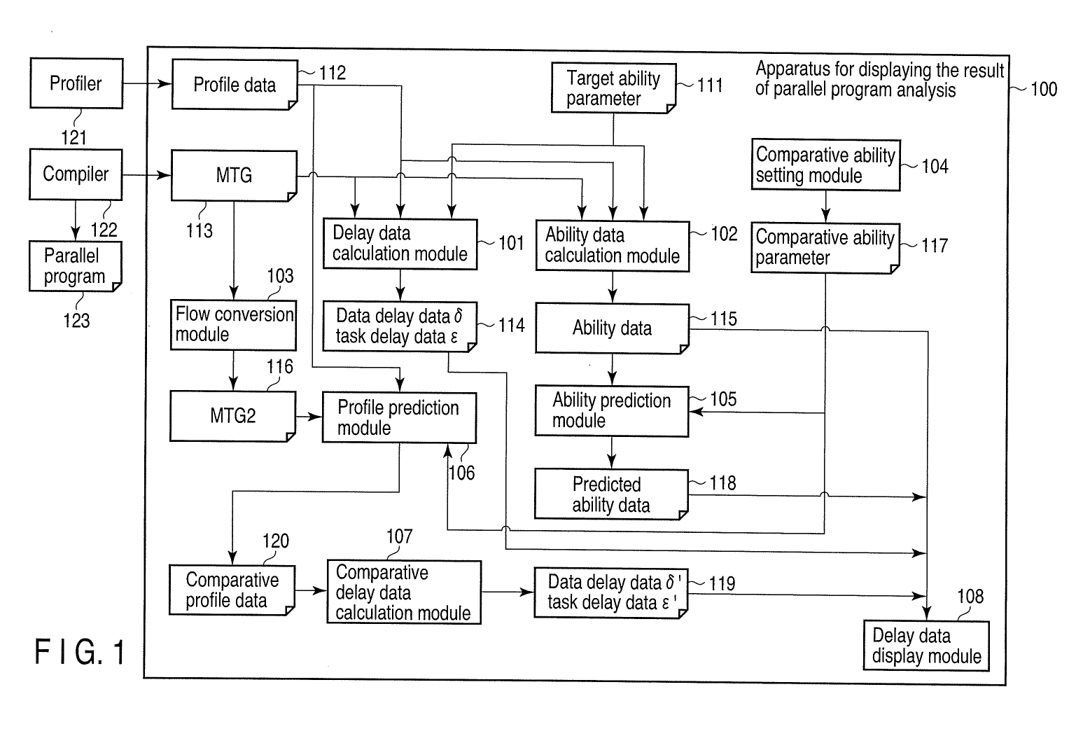

FIG. 1 is a block diagram showing the configuration of an apparatus for displaying the result of parallel program analysis, according to an embodiment. The processes this apparatus performs are implemented by a computer program.

The apparatus 100 for displaying the result of parallel program analysis has a delay data calculation module 101, an ability data calculation module 102, a flow conversion module 103, a comparative ability setting module 104, an ability prediction module 105, a profile prediction module 106, a comparative delay data calculation module 107, and a delay data display module 108.

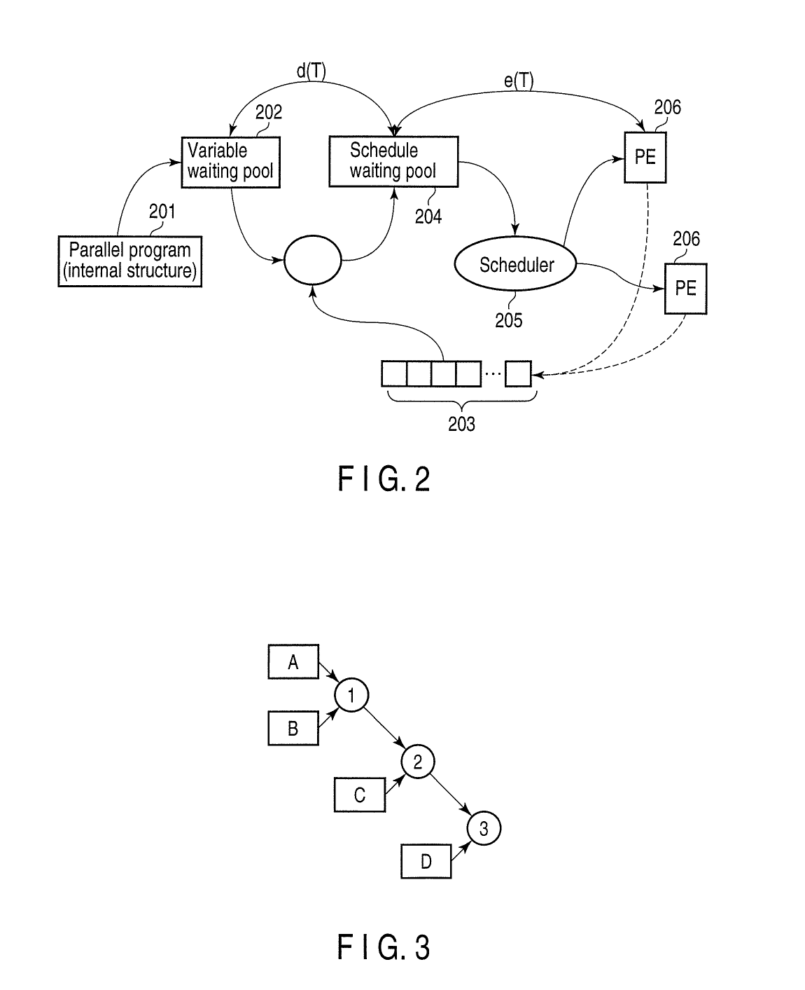

Before describing the modules constituting the apparatus 100, the lifecycle of a task registered in the parallel program will be explained. FIG. 2 is a diagram illustrating the lifecycle of a task. The “task” is one of the units of the parallel program, which are executed one by one.

A task is acquired from parallel program 201 and evaluated. The task is then input to a variable waiting pool 202. The task remains in variable waiting pool 202 until the variables needed for executing the task are registered in a variable pool 203. If these variables are registered in the variable pool 203, the task is input from the variable waiting pool 202 to a schedule waiting pool 204. The task remains in the schedule waiting pool 204 until a scheduler allocates it to a processing circuit (i.e., processor element, PE) 206. The time the task needs to move from the variable waiting pool 202 to the schedule waiting pool 204 is known as “data delay (δ)”, and the time that elapses from the input of task to the processing circuit to the execution of task in the processing circuit is known as “task delay (ε)”.

That is:

Data delay δ=(time of input to schedule

waiting pool)−(time of input to variable waiting

pool); and

Task delay ε=(start of execution in PE)−

(time of input to schedule waiting pool).

These delay data items (δ, ε) have been calculated from input data, such as profile data 112 (e.g., evaluated time of task, start time of task and task processing time).

The data input to the apparatus 100 for displaying the result of parallel program analysis will be described. Input to the apparatus 100 are: target ability parameter 111, profile data 112, task-dependency graph (multi-task-graph, or MTG) 113.

The target ability parameter 111 describes the data about multi-core processors, each having a plurality of processing circuits, and the data about the environment in which the parallel program is executed. The data about multi-core processors includes the number of times each multi-core processor process data, the operating frequency of each multi-core processor, and the processing speed thereof. The data about the environment is, for example, the speed of data transfer between the multi-core processors.

The profile data 112 is provided by a profiler 121 when the multi-core processors execute a parallel program 123. The profile data 112 describes the time required for executing each task of the parallel program, the behavior of the task, and the like, when the multi-core processors execute the parallel program 123.

The task-dependency graph 113 is generated by a compiler 122 when the parallel program 122 is compiled. The task-dependency graph 113 describes the interdependency of the tasks registered in the parallel program 122 and the data obtained by calculating the tasks. FIG. 3 visualizes the contents of the task-dependency graph 113.

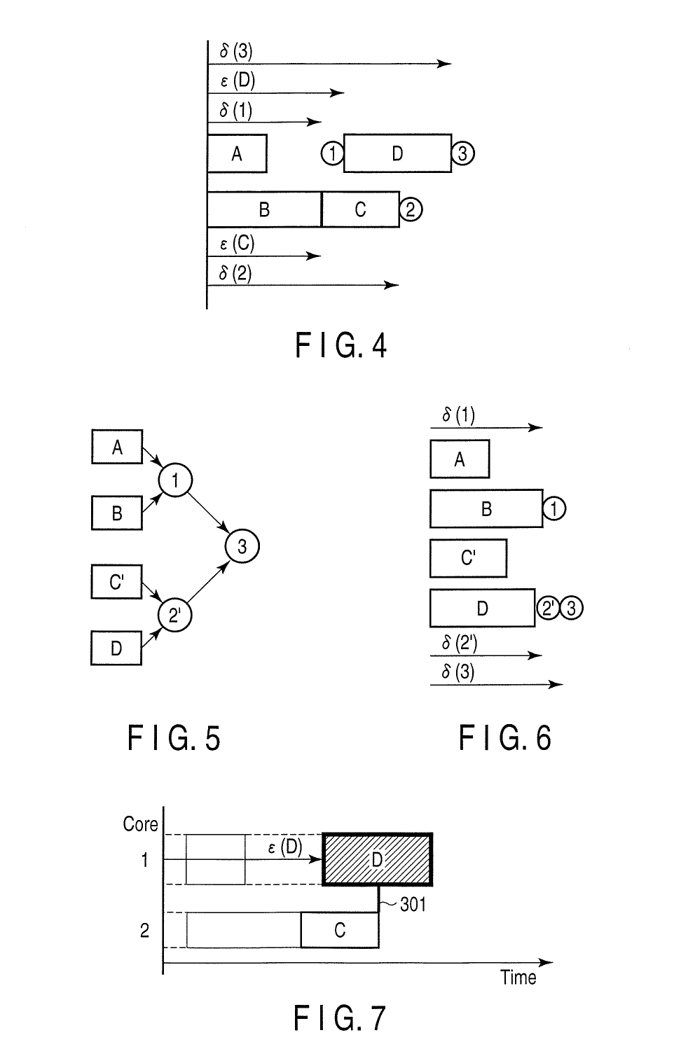

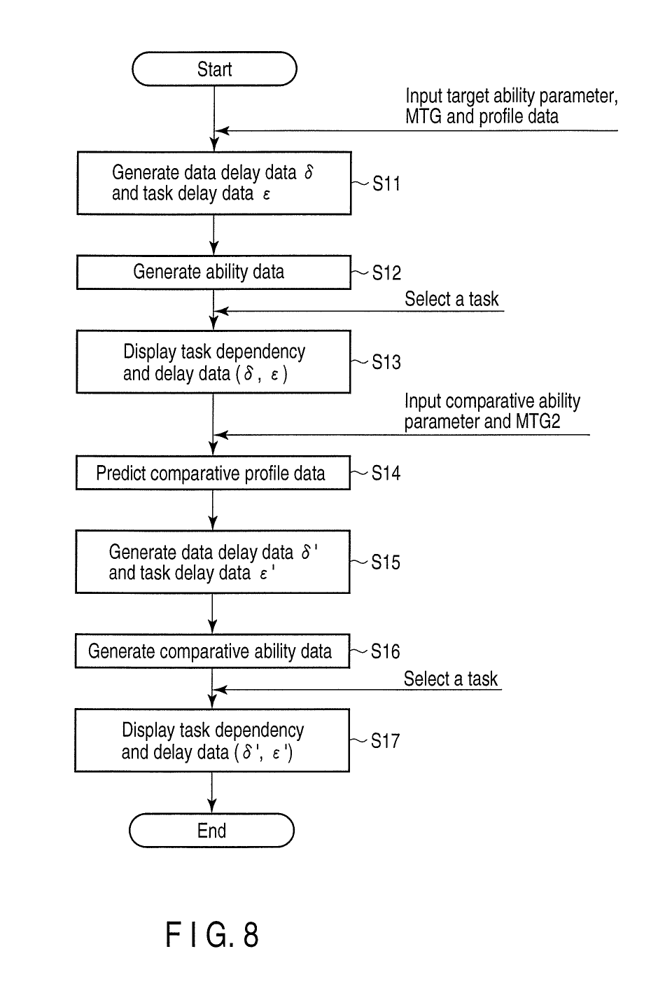

FIG. 4 is a diagram visualizing the contents described in the profile data 112. The profile data shown in FIG. 4 is based on the profile data generated by a multi-core processor having two processing circuits, which has executed the tasks shown in the task-dependency graph of FIG. 3.

As shown in FIG. 3 and FIG. 4, task A, task B, task C and task D are registered in the parallel program 123. The task A and the task B generate data 1. The task C generates data 2. The task D uses the data 2, generating data 3.

The data delay of the task A is data delay δ (1). The data delay of the task D is data delay δ (2). Note that data delays δ (2) and δ (3) are delays that exist when a dummy task (potential task) is detected, which is not displayed when completely executed.

The delay of the task C is task delay δ (C). The delay of the task D is task delay δ (D). The task A and the task B undergo no delays, because they are executed immediately after the program is executed.

The ability data calculation module 102 calculates the actual ability of the processor, which includes operating rate, use rate, occupation rate, and computation amount for each task. The ability data calculation module 102 calculates the floating point number operating per second (FLOPS) from the target ability parameter 111. FLOPS is: (clock)×(number of processing circuits)×(number of times the floating point number operating has been repeated per clock). The ability data calculation module 102 calculates the efficiency of each task and the operating rate of each processing circuit (=total operating time/system operating time), from the profile data 112 and task-dependency graph 113, as will be explained later.

If the profile data describes the dependency of tasks, the ability data calculation module 102 can calculate the efficiency of each task and the operating rate of each processing circuit (=total operating time/system operating time), without referring to the task-dependency graph 113.

The delay data calculation module 101 generates date delay data δ and task delay data ε about each task registered in the parallel program 123, from the profile data 112 and task-dependency graph 113. If the profile data describes the interdependency of tasks, the delay data calculation module 101 can generate the data delay data 114 (data delay data δ, task delay data ε), without referring to the task-dependency graph 113.

When operated by an operator, the comparative ability setting module 104 sets a comparative ability parameter that differs in content from the target ability parameter 111. That is, the comparative ability setting module 104 sets, for example, a comparative ability parameter 117 that differs from the target ability parameter 111 in terms of the number of processing circuits.

The ability prediction module 105 predicts the efficiency of each task if the comparative ability parameter 117 is set, on the assumption that the initial target ability parameter 111 is proportional to the comparative ability parameter 117 changed. The ability prediction module 105 generates and outputs predicted ability data 118.

When operated by the operator, the flow conversion module 103 changes the task-dependency graph 113, and outputs the task-dependency graph 113, as second task-dependency graph (MTG2) 116. FIG. 5 shows the second task-dependency graph obtained by changing the task-dependency graph shown in FIG. 4. As seen from FIG. 5, the task C and data 2 are changed, and task C′ and task D generate data 2′ and data 3.

The profile prediction module 106 predicts the data delay data 114 (data delay data δ, task delay data ε) from the profile data 112 when the second task-dependency graph 116 and comparative ability parameter 117 are input to it.

If only the second task-dependency graph 116 is input to it, the profile prediction module 106 generates comparative profile data 120, by using the profile data 112, the second task-dependency graph 116 and target ability parameter 111. If only the comparative ability parameter 117 are input to it, the profile prediction module 106 generates the comparative profile data 120, by using the profile data 112, task-dependency graph 113 and comparative ability parameter 117. If the second task-dependency graph 116 and comparative ability parameter 117 are input to it, the profile prediction module 106 generates comparative profile data 120, by using the profile data 112, second task-dependency graph 116 and comparative ability parameter 117.

The profile prediction module 106 predicts the comparative profile data 120 under new conditions, from the profile data 112, comparative ability parameter 117 (or target ability parameter 111) and second task-dependency graph 116 (or task-dependency graph 113). Alternatively, the profile prediction module 106 may use the data delay data 114 (data delay data δ, task delay data ε) and the second task-dependency graph 116 and/or comparative ability parameter 117, in order to generate the comparative profile data 120.

The comparative delay data calculation module 107, for example, rearranges the tasks described in the profile data 112, in accordance with the overlapping parts of task delays under new conditions. Rearranging the tasks so, the comparative delay data calculation module 107 generates the comparative profile data 120.

FIG. 6 visualizes the contents of the comparative profile data generated as a multi-core processor that has four processing circuits and performs the tasks shown in the task-dependency graph of FIG. 5. That is, the comparative ability setting module 104 changes the number of processing circuits, described as “2” in the target ability parameter 111, to “4,” and the number of processing circuits, so changed, is described in the comparative ability parameter 117.

As shown in FIG. 6, the task A, task B, task C′ and task D are performed at the same time, and data 2′ and data 3 are output as the result of performing the task D.

The comparative delay data calculation module 107 generates data delay data 119 (data delay data δ′, task delay data ε′) from the comparative profile data 120, in the same way as the delay data calculation module 101 does.

The delay data display module 108 displays the result of analyzing the parallel program, on the basis of the data delay data 114 (data delay data δ, task delay data ε). Further, in response to an instruction input by the operator, the delay data display module 108 displays the result of analyzing the parallel program, on the basis of the data delay data 119 (data delay data δ′, task delay data ε′).

FIG. 7 is a diagram showing a result of parallel program analysis performed on the basis of the task-dependency graph 113 and the delay data 114 (data delay data δ, task delay data ε). If the operator selects a task, the task selected is displayed emphatically. In FIG. 7, the task D is displayed emphatically, because it has been selected. Only the task that depends on the task selected is displayed, and other tasks are not displayed. The line 301 connecting the selected task to the task depending on the selected task is displayed, showing that these tasks depend on each other. Further, based on the delay data 114 (data delay data δ, task delay data ε), an arrow is displayed, whose length indicates the wait time. Observing the data thus displayed, the user of the apparatus 100 can easily determine what he or she should do to improve the parallel program most effectively.

As shown in FIG. 7, the pointer may overlap the task D. In this case, the delay data display module 108 may display, as shown in FIG. 7, the data about the task D, which a chip has extracted from ability data 115. Alternatively, the delay data display module 108 may display the ability data 115 in another window.

On the basis of the result of parallel program analysis, the delay is decomposed into a delay of input data delay and a task delay in the scheduler. The data display module 108 displays these delays, as a bottleneck, to the designer of the parallel program. A data delay, if any, suggests a problem with the interdependency of tasks. In order to solve the problem, the flow of the task-dependency graph 113 may be changed. On the other hand, a task delay, if any, may result from the change in the ability parameter of the target machine (for example, use of more processing circuits). The apparatus 100 can therefore give the guidelines for improving the parallel program and the environment of executing the parallel program (i.e., ability parameters).

Since the delay data calculation module 101 generates the data delay data and the task delay data, both concerning each task, the guidelines for improving the parallel program can easily be given to the designer of the parallel program. Moreover, any input parameter changed is analyzed and the result of analyzing the parameter is displayed. Seeing this result, the designer can confirm the parameter change. Thus, the apparatus 100 can help the designer to set ability parameters and correct the interdependency of tasks.

The sequence of processes performed by the apparatus 100 for displaying the result of parallel program analysis will be explained below.

First, the target ability parameter 111, profile data 112 and task-dependency graph (MTG) 113 are input to the apparatus 100 for displaying the result of parallel program analysis. In the apparatus 100, the delay data calculation module 101 generates data delay data δ and task delay data ε for each task registered in the parallel program 123 (block S11). Then, the ability data calculation module 102 generates ability data (block S12).

If the operator (programmer) selects a task, the data display module 108 displays, on its display screen, the interdependence of the selected task and any task depending on the selected task, the data delay data δ, and the task delay data ε (block S13).

Next, in accordance with the guideline acquired from the data display on the display screen, the operator (programmer) may input the second task-dependency graph (MTG2) 116 and comparative ability parameter 117 generated by the flow conversion module 103 and comparative ability setting module 104, respectively. In this case, the profile prediction module 106 generates comparative profile data 120 (block S14). The comparative delay data calculation module 107 generates data delay data δ′ and task delay data ε′ for each task (block S15). The ability prediction module 105 generates predicted ability data 118 (block S16).

If the operator (programmer) may select a task, the data display module 108 displays, on its display screen, the interdependence of the selected task and any task depending on the selected task, the data delay data δ′, and the task delay data ε′ (block S17).

As the process are performed in the sequence described above, the guideline for improving the parallel program 123 and the guideline for changing the environment of executing the parallel program 123.

In this embodiment, the processes of analyzing the parallel program and the process of displaying the result of the analysis are implemented by a computer program. The same advantages can therefore be achieved as in the embodiment, merely by installing the computer programs in ordinary computers by way of computer-readable storage media. This computer program can be executed not only in personal computers, but also in electronic apparatuses incorporating a processor.

The method used in conjunction with the embodiment described above can be distributed as a computer program, recorded in a storage medium such as a magnetic disk (flexible disk, hard disk, etc.), an optical disk (CD-ROM, DVD, etc.), a magneto-optical disk (MO), or a semiconductor memory.

The storage medium can be of any storage scheme as long as it can store programs in such a way that computers can read the programs from it.

Further, the operating system (OS) working in a computer in accordance with the programs installed into the computer from a storage medium, or the middleware (MW) such as database management software and network software may perform a part of each process in the present embodiment.

Still further, the storage media used in this embodiment are not limited to the media independent of computers. Rather, they may be media storing or temporarily storing the programs transmitted via LAN or the Internet.

Moreover, for this embodiment, not only one storage medium, but two or more storage media may be used, in order to perform various processes in the embodiment. The storage media or media can be of any configuration.

The computer used in this invention performs various processes in the embodiment, on the basis of the programs stored in a storage medium or media. The computer may be a stand-alone computer such as a personal computer, or a computer incorporated in a system composed of network-connected apparatuses.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for displaying the result of parallel program analysis, comprising:
a delay data calculator configured to calculate first data delay data and first task delay data based on a target ability parameter describing an ability of an environment of executing a parallel program, profile data of the parallel program, and a first task-dependency graph representing dependence of tasks described in the parallel program, the first data delay data representing time elapsing from a start of obtaining variables needed for executing a first task comprised in the tasks to acquisition of all of the needed variables, the first task delay data representing the time elapsing from the acquisition of the variable to execution of the first task; and
a delay data display module configured to display, on a display screen, an image showing the first task, a task on which the first task depends, the first task delay data, and the first data delay data, based on the first task delay data and the first data delay data.

2. The apparatus of claim 1, further comprising:
a generator configured to generate a comparative ability parameter by changing the ability described in the target ability parameter;
a graph generating module configured to generate a second task-dependency graph by changing the first task-dependency graph;
a predicting module configured to predict comparative profile data from the profile data, one of the first task-dependency graph and the second task-dependency graph, and one of the ability parameter and the comparative ability data, when at least one of the second task-dependency graph generated and the comparative ability parameter are inputted to the predicting module; and
a second data delay data calculator configured to calculate second task delay data and second data delay data based on the comparative profile data predicted by the predicting module, the second data delay data representing time elapsing from a start of obtaining variables needed for executing the first task to acquisition of all of the needed variables, the second task delay data representing the time elapsing from the acquisition of the variable to execution of the first task,
wherein the delay data display module is configured to display, on the display screen, an image showing the first task, the task on which the first task depends, the second task delay data, and the second data delay data, based on the second task delay data and the second data delay data.

3. The apparatus of claim 2, wherein the second data delay data calculator is configured to calculate the second task delay data and second data delay data, based on the first task delay data, the first data delay data, the first task-dependency graph, the second task-dependency graph, and one of the ability parameter and the comparative ability parameter.

4. The apparatus of claim 2, wherein the graph generating module is configured to generate the second task-dependency graph in response to an input operation of an operator.

5. The apparatus of claim 1, further comprising an ability data calculator configured to calculate ability data representing an actual ability of a processor, based on the target ability parameter, the profile data, and the first task-dependency graph.

6. A method of displaying the result of parallel program analysis, the method comprising:
calculating first data delay data and first task delay data based on a target ability parameter describing an ability of an environment of executing a parallel program, profile data of the parallel program, and a first task-dependency graph representing dependence of tasks described in the parallel program, the first data delay data representing time elapsing from a start of obtaining variables needed for executing a first task comprised in the tasks to acquisition of all of the needed variables, the first task delay data representing the time elapsing from the acquisition of the variable to execution of the first task; and
displaying, on a display screen, an image showing the first task, a task on which the first task depends, the first task delay data, and the first data delay data, based on the first task delay data and the first data delay data.

7. The method of claim 6, further comprising:
generating a comparative ability parameter by changing the ability described in the target ability parameter;
generating a second task-dependency graph by changing the first task-dependency graph;
predicting comparative profile data from the profile data, one of the first task-dependency graph and the second task-dependency graph, and one of the ability parameter and the comparative ability data, when at least one of the second task-dependency graph generated and the comparative ability parameter are inputted to the predicting module; and
calculating second task delay data and second data delay data based on the comparative profile data predicted by the predicting module, the second data delay data representing time elapsing from a start of obtaining variables needed for executing the first task to acquisition of all of the needed variables, the second task delay data representing the time elapsing from the acquisition of the variable to execution of the first task,
wherein the displaying comprises displaying, on the display screen, an image showing the first task, the task on which the first task depends, the second task delay data, and the second data delay data, based on the second task delay data and the second data delay data.

8. The method of claim 7, wherein the calculating of the second task delay data comprises calculating the second task delay data and second data delay data, based on the first task delay data, the first data delay data, the first task-dependency graph, the second task-dependency graph, and one of the ability parameter and the comparative ability parameter.

9. The method of claim 7, wherein the generating of the second task-dependency graph comprises generating the second task-dependency graph in response to an input operation of an operator.

10. The method of claim 6, further comprising calculating ability data representing an actual ability of a processor, based on the target ability parameter, the profile data, and the first task-dependency graph.

11. A non-transitory computer readable medium having stored thereon a computer program which is executable by a computer, the computer program controls the computer to execute functions of:
calculating first data delay data and first task delay data based on a target ability parameter describing an environment of executing a parallel program, profile data of the parallel program, and a first task-dependency graph representing dependence of tasks described in the parallel program, the first data delay data representing time elapsing from a start of obtaining variables needed for executing a first task comprised in the tasks to acquisition of all of the needed variables, the first task delay data representing the time elapsing from the acquisition of the variable to execution of the first task; and
displaying, on a display screen, an image showing the first task, a task on which the first task depends, the first task delay data, and the first data delay data, based on the first task delay data and the first data delay data.

12. The medium of claim 11, further comprising:
generating a comparative ability parameter by changing the ability described in the target ability parameter;
generating a second task-dependency graph by changing the first task-dependency graph;
predicting comparative profile data from the profile data, one of the first task-dependency graph and the second task-dependency graph, and one of the ability parameter and the comparative ability data, when at least one of the second task-dependency graph generated and the comparative ability parameter are inputted to the predicting module; and
calculating second task delay data and second data delay data based on the comparative profile data predicted by the predicting module, the second data delay data representing time elapsing from a start of obtaining variables needed for executing the first task to acquisition of all of the needed variables, the second task delay data representing the time elapsing from the acquisition of the variable to execution of the first task,
wherein the displaying comprises displaying, on the display screen, an image showing the first task, the task on which the first task depends, the second task delay data, and the second data delay data, based on the second task delay data and the second data delay data.

13. The medium of claim 12, wherein the calculating of the second task delay data comprises calculating the second task delay data and second data delay data, based on the first task delay data, the first data delay data, the first task-dependency graph, the second task-dependency graph, and one of the ability parameter and the comparative ability parameter.

14. The medium of claim 12, wherein the generating of the second task-dependency graph comprises generating the second task-dependency graph in response to an input operation of an operator.

15. The medium of claim 11, further comprising calculating ability data representing an actual ability of a processor, based on the target ability parameter, the profile data, and the first task-dependency graph.
